(19) United States
(12) Patent Application Publication
(10) Pub. No.: US 2003/0014501 A1
(43) Pub. Date: Jan. 16, 2003

(54) Predicting the popularity of a text-based object

(76) Inventors: Andrew R. Golding, Waltham, MA (US); Michael J. Witbrock, Austin, TX (US); Alden DoRosario, Acton, MA (US)

Correspondence Address: BRIAN J. COLANDREO, Fish & Richardson P.C., 225 Franklin Street, Boston, MA, 02110-2804, US

(21) Appl. No.: 09/902,422

(22) Filed: Jul. 10, 2001

(51) Int. Cl. G06F 15/16; G06F 17/30; G06F 7/00

(52) U.S. Cl. 709/218; 707/3

(57) ABSTRACT

A popularity predicting process for determining the popularity of a text-based object includes a query analysis process for analyzing a query to determine a plurality of links to Internet objects relating to the query. A link weighting process determines the individual link strength of each of the plurality of links, thus generating a plurality of link strengths. A link strength summing process determines the sum of the plurality of link strengths, wherein the sum corresponds to the popularity of the text-based object.

### TECHNICAL FIELD

This invention relates to predicting the popularity of various objects, and more particularly to text-based objects.

### BACKGROUND

The Internet is a phenomenal research tool in that it allows millions of users to access millions of pages of data. Unfortunately, as the number of web sites offering quality information and the quantity of information itself continues to grow, the Internet becomes more difficult to navigate.

The Internet can be viewed as a collection of documents, wherein these documents are typically interconnected via hyperlinks. Search queries are used as the primary means for retrieving these documents. Whenever a user submits one of these queries to a search engine, a list of results is generated which includes hyperlinks that connect each search result to the appropriate Internet document.

The way in which these documents are ranked within the list of results (in relation to the query) is constantly evolving as the Internet continues to evolve. Initially, Internet search engines simply examined the number of times that a query search term appeared within the document, such that the greater the number of times that a search term appeared, the more relevant the document was considered and the higher it was ranked within the list of results.

More advanced ranking methods examine the quality of the documents themselves. Specifically, the number of links coming into a document and the number of links leaving that document are examined. Those documents that have a considerable number of documents linked to them are considered information authorities and those documents that are linked to a considerable number of documents are considered information hubs. Naturally, the greater the number of these links, the higher the quality (and ranking) of the document. In an effort to further enhance the relevance of the list of documents generated in response to a query, search engines examine the words of the query entered and compare them to the previous queries that included the same words or associated words (i.e., words having known associations with the words of the query). This allows the search engine to further predict (or suggest) what additional search terms the user might want to include in the query to further narrow the results of the search.

### SUMMARY

According to an aspect of this invention, a popularity predicting process for determining the popularity of a text-based object includes a query analysis process for analyzing a query to determine a plurality of links to Internet objects relating to the query. A link weighting process determines the individual link strength of each of the plurality of links, thus generating a plurality of link strengths. A link strength summing process determines the sum of the plurality of link strengths, such that the sum corresponds to the popularity of the text-based object.

One or more of the following features may also be included. The link weighting process includes a click analysis process for determining a link use statistic for each of the plurality of links, such that the link use statistic of each link affects the strength of that link. The link use statistic is an integer specifying the number of times that that link was used prior to the query analysis process analyzing the query. The link weighting process includes a content analysis process for analyzing the relevancy between each of the plurality of Internet objects and the query, such that the relevancy value of each Internet object affects the strength of the link to that Internet object. The link weighting process includes a link structure analysis process for analyzing the quality of each of the plurality of Internet objects, such that the quality value of each Internet object affects the strength of the link to that Internet object. The link structure analysis process includes an incoming link analysis process for determining the number of objects linked to each of the plurality of Internet objects, such that the incoming link value of each Internet object is directly proportional to the number of objects linked to that Internet object. The incoming link value affects the quality value of that Internet object. The link structure analysis process includes an outgoing link analysis process for determining the number of objects that each of the plurality of Internet objects is linked to, such that the outgoing link value of each Internet object is directly proportional to the number of objects that the Internet object is linked to. The outgoing link value affects the quality value of that Internet object.

Each link strength is a relevancy score. The relevancy score is a percentage. The query is a text-based query and includes at least a portion of the text of the text-based object. The text-based object is a query. The text-based object is a document. The plurality of links is a user-definable number of links and the popularity predicting process further includes a link limitation process for defining the user-definable number of links. The popularity predicting process includes an object conversion process for converting the text-based object into the query. The query analysis process and link weighting process may be incorporated into a search engine, as opposed to being incorporated into the popularity predicting process.

According to a further aspect of this invention, a method for determining the popularity of a text-based object includes: analyzing a query to determine a plurality of links to Internet objects relating to the query; determining the individual link strength of each of the plurality of links, thus generating a plurality of link strengths; and determining the sum of the plurality of link strengths, such that this sum corresponds to the popularity of the text-based object.

One or more of the following features may also be included. The step of determining the individual link strength includes determining a link use statistic for each of the plurality of links, such that the link use statistic of each link affects the strength of that link. The step of determining the individual link strength includes analyzing the relevancy between each of the plurality of Internet objects and the query, such that the relevancy value of each Internet object affects the strength of the link to that Internet object. The step of determining the individual link strength includes analyzing the quality of each of the plurality of Internet objects, such that the quality value of each Internet object affects the strength of the link to that Internet object. The step of analyzing the quality of each of the plurality of Internet objects includes determining the number of objects linked to each of the plurality of Internet objects to determine an incoming link value for each Internet object, such that the incoming link value of each Internet object is directly proportional to the number of objects linked to that Internet object. This incoming link value affects the quality value of that Internet object. The step of analyzing the quality of each of the plurality of Internet objects includes determining the number of objects that each of the plurality of Internet objects is linked to, thus determining an outgoing link value for each Internet object, such that the outgoing link value of each Internet object is directly proportional to the number of objects that that Internet object is linked to. This outgoing link value affects the quality value of that Internet object. The query is a text-based query and the method for determining the popularity of a text-based object further includes incorporating at least a portion of the text of the text-based object in the query. The plurality of links is a user-definable number of links and the method for determining the popularity of a text-based object further includes defining the user-definable number of links.

According to a further aspect of this invention, a computer program product residing on a computer readable medium having a plurality of instructions stored thereon which, when executed by the processor, cause that processor to: analyze a query to determine a plurality of links to Internet objects relating to the query; determine the individual link strength of each of the plurality of links, thus generating a plurality of link strengths; and determine the sum of the plurality of link strengths, such that this sum corresponds to the popularity of the text-based object.

One or more of the following features may also be included. The computer readable medium is a random access memory (RAM), a read only memory (ROM), or a hard disk drive.

According to a further aspect of this invention, a processor and memory are configured to: analyze a query to determine a plurality of links to Internet objects relating to the query; determine the individual link strength of each of the plurality of links, thus generating a plurality of link strengths; and determine the sum of the plurality of link strengths, such that this sum corresponds to the popularity of the text-based object.

One or more of the following features may also be included. The processor and memory are incorporated into a personal computer, a network server, or a single board computer.

One or more advantages can be provided from the above. The schemes of searching for and rating information on the Internet are combined to deliver more robust results. By combining these schemes, the popularity of an unrated object can be predicted Further, this predicted rating of the object is based on the relevance and quality of the objects related to it and not the unrated object itself.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of the Internet;

FIG. 2 is a diagrammatic view of the popularity predicting process;

FIG. 3 is a flow chart of the method for determining the popularity of a text-based object;

FIG. 4. is a diagrammatic view of another embodiment of the popularity predicting process, including a processor and a computer readable medium, and a flow chart showing a sequence of steps executed by the processor; and

FIG. 5. is a diagrammatic view of another embodiment of the popularity predicting process, including a processor and memory, and a flow chart showing a sequence of steps executed by the processor and memory.

Like reference symbols in the various drawings indicate like elements.

### DETAILED DESCRIPTION

The Internet and the World Wide Web can be viewed as a collection of hyperlinked documents with search engines as a primary interface for document retrieval. Search engines (e.g., Lycos, Yahoo, Google) allow the user to enter a query and perform a search based on that query. A list of potential matches is then generated that provides links to potentially relevant documents. Search engines typically also offer to the user some form of taxonomy that allows the user to manually navigate to the information they wish to retrieve.

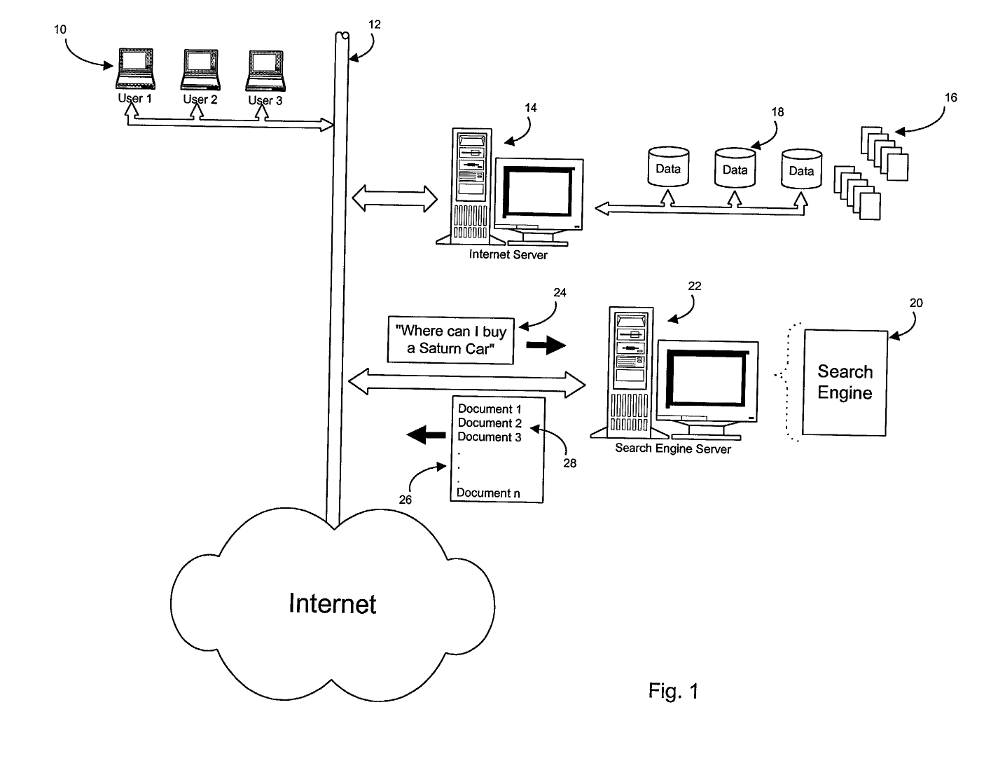

Referring to FIG. 1, there is shown a number of users 10 accessing the Internet via a network 12 that is connected to Internet server 14. The Internet server 14 serves web pages and Internet-based documents 16 to user 10. Internet server 14 typically incorporates some form of database 18 to store and serve documents 16.

When user 10 wishes to search for information on a specific topic, user 10 utilizes search engine 20 running on search engine server 22. User 10 enters query 24 into search engine 20, which provides a list 26 of potential sources for information related to the topic of query 24. For example, if user 10 entered the query “Where can I buy a Saturn Car?”, list 26 would be generated which enumerates a series of documents that provide information relating to the query entered. Each entry 28 on list 26 is a hyperlink to a specific relevant document (i.e., web page) 16 on the Internet. These documents 16 may be located on search engine server 22, Internet server 14, or any other server (not shown) on the Internet.

Search engine 20 determines the ranking of the entries 28 on list 26 by examining the documents themselves to determine certain factors, such as: the number of documents linked to each document; the number of documents that document is linked to; the presence of the query terms within the document itself; etc. This results in a score (not shown) being generated for each entry, such that these entries are ranked within list 26 in accordance with these scores.

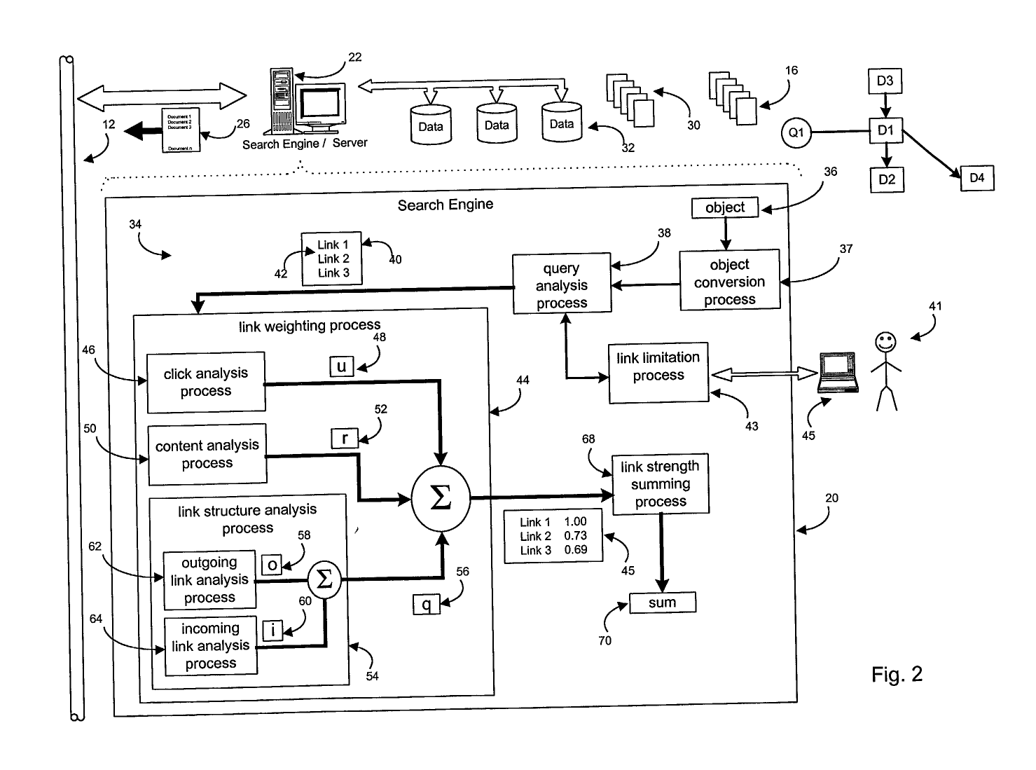

Now referring to FIG. 2, there is shown search engine 20 that analyzes the hundreds of millions of documents 16 available to users of the Internet. These documents can be stored locally on server 22 or on any other server or combination of servers connected to network 12. As stated above, when search engine 20 provides list 26 to user 10 in response to query 24 being entered into search engine 20, the individual entries in list 26 are arranged in accordance with their perceived level of relevance (or match). This relevance level is determined in a number of different ways, each of which examines the relationship between various Internet objects (e.g., a query, a document, a web page, an ASCII file, etc.).

As a query contains specific search terms (e.g., “Where can I buy a Saturn Car?”), early search engines used to simply examine the number of times that each of these search terms appeared within the documents scanned by the search engine. Web designers typically incorporate hidden metatags into their web documents to bolster the position of their web page (or web-based document) on list 26. Metatags are lines of code that redundantly recite the specific search terms that, if searched for by a user, the designer would like their web page to be listed high in the list 26 of potentially matching documents. For example, if a web designer wanted their web page document to be ranked high in response to the query “Where can I buy a Saturn Car?”, the designer may incorporate a metatag that recites the words “Saturn” and “car” 100 times each. Therefore, when the search engine scans this document (which is typically done off line and not in response to a search by a user), the large number of occurrences of the words “Saturn” and “car” will be noted and stored in the search engine's database. Accordingly, when a user enters this query into search engine 20, the document that contains this metatag will be highly ranked on this list. As easily realized, since this method of ranking simply examines the number of times a specific term appears in a document, the method does not in any way gauge the quality of the document itself.

In response to this shortcoming, more sophisticated methods of ranking documents were developed which examined the quality of the documents themselves (as opposed to merely the number of times that a search term was embedded within the document's HTML code). These search engines rank the quality of documents by examining, among other things, the number of documents that are linked to the document being ranked. Specifically, if a document has a considerable number of documents linked to it, it is considered an information authority. For example, document D1 is an authority for document D3, since document D3 is linked to document D1. The theory behind this rule is that if good information is available on the Internet, people will link to it to bolster the substantive value of their own web site. Naturally, the greater the number of documents linked to the document being ranked, the stronger the authority value for that document.

However, web-based documents need not be information authorities to be valued by search engines. Search engine 20 will also examine, among other things, the number of documents that the document being ranked is linked to. Specifically, if a document is linked to a considerable number of documents, that document is considered an information hub. For example, document D1 is a hub in that it is linked to documents D2 and D4. The theory behind this rule is the same as the previous one, namely if good information is available on the Internet, it will be found and pointed (i.e., linked) to. Naturally, the greater the number of documents that the document being ranked is linked to, the stronger the hub value for that document.

As is known in the art, the computation of a document's information authority and information hub values is more complex than the cursory description provided above. These values are determined by using an iterative process that initially sets the authority and hub values for each document to one. Multiple iterations are then performed, wherein the current authority and hub values are considered to be accurate and new authority and hub values are then computed based on these previously accepted values. Accordingly, a document that has many hubs pointing to it is given a higher authority weight in the next iteration. This algorithm continues until the authority and hub values each converge.

Please realize that the above-listed sorting and ranking methods are used both for ranking search results and for ordering indexes to be navigated manually. While the discussion was primarily focused on queries and search engines, these methods are also utilized to determine the placement of documents within manually navigated indexes.

Thus far, the relationships that the above-described methods have scrutinized have all been document-to-document relationships. However, search engines examine other criteria to further enhance the ranking of their documents. Specifically, search engines typically keep track of the queries that have been run on them and the list of hyperlinks generated as a result of each of these queries. Additionally, search engines monitor how often a user (for any given list and query) goes to a particular item on the list of search results; returns to the list after going to a document; and selects a different document. The theory behind this is that substantive quality information attracts users and, therefore, if a user follows a hyperlink to a document, it is indicative of quality information being available at that site. An example of scrutinizing this query-to-document criteria is as follows: user 10 issues query Q1; a list is generated which includes document D1, D2, and D3; user 10 selects document D1, user 10 then returns to the list; user 10 then selects document D2 and does not return. These actions by user 10 are indicative of low quality (or off topic) information being available in document D1 and high quality (or on topic) information being available in document D2. These queries are stored in the query records 30 on search engine database 32. The hyperlink lists generated in response to these queries and the statistics concerning the use of these links are also stored in database 32.

Search engines can further enhance their document ranking accuracy by comparing stored queries (query-to-query relationships) to make suggestions to the user concerning modifications or supplemental search terms that would better tailor the user's query to the specific information they are searching for. For example, if user 10 entered the query “Saturn” into search engine 20, it is unclear in which direction the user intends this search to proceed, as the word “Saturn” is indicative of a planet, a car company, and a home video game system. Upon reviewing query records 30 and determining that queries containing the word “Saturn” typically also include the words “planet”, “car”, or “game”, search engine 20 may make an inquiry such as “Are you looking for information concerning: the planet Saturn; the car Saturn; or the video game system Saturn?” Depending on which selection the user makes, the user's search will be modified and tailored accordingly. This further allows search engine 20 to return a relevant list of documents in response to a query being entered by the user 10.

Unfortunately, all of the methods discussed thus far have required the existence of a relationship between Internet objects (i.e., documents and queries) in order to rank the strength (or relevance) of the link to a particular document and the quality of the particular document. Specifically, when utilizing document-to-document criteria, the rating of a particular document is based on the number of documents that particular document is linked to and the number of documents linked to that particular document. When utilizing query-to-document criteria to rank a particular document, the rating of that document is based on, among other things, the number of query search terms embedded in that particular document and the number (or percentage) of times a user issuing a query selects the document in question from the list of search results. Further, when utilizing query-to-query criteria, previous queries are compared to the current query to see if further query refinement is possible. In short, all of these various ranking criteria require the preexistence of a relationship between a query and a query, a query and a document, or a document and a document. Additionally, all of the above-listed ranking criteria require the scrutinization of the object itself (either the query or the document) to determine the quality of the object and the relevancy of the object with respect to a specific query.

Popularity predicting process 34 determines the popularity (i.e., rating/ranking) of text-based object 36. As object 36 is text-based, it can be easily converted into a query. An object conversion process 37 converts object 36 into a text-based query. This is accomplished by utilizing all or some of the text of the text-based object 36 as the search terms of the query. Object 36 can be any Internet object (e.g., a query, a document, a web page, an ASCII file, etc.) or any file (such as an ASCII file available on a local area network, an HTML file available on a corporate intranet, etc.), provided it is text-based.

In addition to the direct conversion process discussed above (in which object conversion process 37 merely utilizes the text of text-based object 36 to construct the query), object conversion process 37 can also replace and/or supplement the terms in the original text object with other terms. This enhances the ability to find web documents that are relevant to the essence of the original text-based object. One type of term that could be added is synonyms of the original terms, as found in a thesaurus. Another type of term is so-called “co-queries” (i.e., queries associated with terms in the original text-based object). Queries are considered co-queries if users tend to ask the two queries together within the same session, in that a session is a consecutive sequence of queries issued by a user of a search engine.

To decide whether two queries Q1 and Q2 are co-queries, we count the number of user sessions in which the user asked both Q1 and Q2. If this number of sessions is significantly higher than what we would expect by chance, then we say that queries Q1 and Q2 are co-queries. The number of sessions that we would expect by chance is simply the total number of sessions multiplied by the fraction of sessions that contain query Q1 multiplied by the fraction of sessions that contain query Q2. That is, we assume that the occurrence of query Q1 in a user session is independent of the occurrence of query Q2 in a user session.

We can measure the degree to which the observed number of sessions differs from the expected number of sessions by using any technique for evaluating a ratio between an observed number of events and an expected number of events (e.g., mutual information analysis or a chi-squared test). For example, consider the queries “German shepherd” and “guard dog”. If we analyze the user sessions stored in query records 30 on search engine database 32, let's say we find that “German shepherd” occurs in 0.015% of the user sessions, and “guard dog” occurs in 0.024% of the sessions. We would then expect, by chance, the queries to occur together 0.015%*0.024% or 0.00000360% of the sessions. However, we in fact observe that the queries occur together in 0.0008% of the sessions. Because this number is much larger than what we would expect if the two terms were independent, we conclude that they are co-queries.

Accordingly, if we are given a text-based object such as “German shepherd training”, we could apply our co-query knowledge to transform this text-based object into a query such as: “German shepherd training OR guard dog training”. In so doing, we increase the chances of finding web documents that are relevant to the concept expressed by the original text-based object. Note also that we could simply replace the terms in the text-based object with the co-queries, if desired. For instance, we could transform “German shepherd training” into “guard dog training”. If the original text-based object was “German shepherd”, we could transform it into “guard dog”. In this way, it is possible to generate a query that has no words in common with the original text-based object.

Popularity predicting process 34 includes a query analysis process 38 for analyzing this query (i.e., the query generated from the text of the text-based object 36) to determine a plurality of links to Internet objects relating to that query. Query analysis process 38 is any standard search/query process or algorithm that searches some form of network 12 to find documents related to the search terms of the query. Specifically, if text-based object 36 is a web page containing the following text:

Hi. My name is John and I went to San Diego, Calif. on my vacation. I had a great time and the weather was beautiful;

popularity predicting process 34 determines the popularity (i.e., rating) of object 36 by having object conversion process 37 convert the text of object 36 into a query. Accordingly, for the above-stated example, the query analyzed by query analysis process 38 would be “Hi. My name is John and I went to San Diego, Calif. on my vacation. I had a great time and the weather was beautiful.”. Query analysis process 38 processes this query to generate a plurality of links 40, such that each link points to a document on the Internet (or other network) that is related to the search terms of the query.

Administrator 41 can adjust the total number of links included in the plurality of links 40, as this number is user-definable. Link limitation process 43, which interfaces with computer 45, allows administrator 41 to make such an adjustment.

Popularity predicting process 34 includes a link weighting process 44 for determining the individual link strength of each link 42 in the plurality of links 40. This, in turn, generates a plurality of link strengths 45, one for each link. The manner in which the strength of each individual link 42 (and, therefore, the individual documents within list 40) is determined is based on one or more of the relevance/quality ranking procedures discussed above or any other form of ranking methodology.

While thus far, query analysis process 38 and link weighting process 44 have been described as being part of said popularity predicting process 34, this is not intended to be a limitation of the invention, as processes 38 and 44 can be incorporated into search engine 20.

Link weighting process 44 includes a click analysis process 46 for determining a link use statistic 48 for each of the plurality of links 40 (i.e., Link 1, Link 2, and Link 3). Click analysis process 46 accesses database 32 to obtain the query records 30 (which list the specific queries executed by query analysis process 38), the hyperlink lists generated in response to these queries, and the statistics concerning the use of these links. Expanding on the example stated above, the search terms of the current query (i.e., “Hi. My name is John and I went to San Diego, Calif. on my vacation. I had a great time and the weather was beautiful.”) are compared to the search terms of queries previously processed by query analysis process 38. Upon reviewing query records 30, click analysis process 46 determines that queries that include the words “John”, San Diego”, and “weather” typically generate a list of links including discrete links “Link 1” (a link to document D1), Link 2” (a link to document D2), and “Link 3” (a link to document D3) from plurality of links 40. Of these links, “Link 1” is typically accessed 75% of the time, “Link 2” is accessed 50% of the time, and “Link 3” is accessed 25% of the time. Accordingly, click analysis process 46 applies a link use statistic 48 to each of these links in accordance with these statistics. These link use statistics can be in the form of a relevancy score (e.g., 0.75, 0.50, and 0.25), as listed above. Alternatively, query records 30 can keep track of the number of times a user accesses a particular link and these link use counts can be used as link use statistics. For example, if “Link 1” was accessed 15,000 times, “Link 2” was accessed 10,000, and “Link 3” was accessed 5,000 times, these link use statistics for “Link 1”, “Link 2”, and “Link 3” are: 15,000, 10,000, and 5,000 respectively. Naturally, these link use statistics 48 can be normalized and/or weighted if desired.

Please realize that in light of the fact that search engines typically process millions of queries per day, query records 30 are quite extensive and voluminous. Therefore, it is probable that link use statistics exist in query records 30 for any link 42 generated in response to a query entered by a user. Further, while plurality of links 40 is shown to include only three links, this is for illustrative purposes only.

Link weighting process 44 further includes a content analysis process 50 for analyzing the relevancy of each of the plurality of Internet objects pointed (or linked) to by the plurality of links 40. This, in turn, generates a relevancy statistic 52 for each of the plurality of links 40 (i.e. Link 1, Link 2, and Link 3) and, therefore, each of the Internet objects linked to (i.e., D1, D2, and D3 respectively). As described above, this relevancy statistic 52 is based on the level of relevancy between the query processed by query analysis process 38 and the individual document which each of the plurality of links 40 point to. Expanding on the above-stated example, the specific search terms of the query processed by query analysis process 38 are “Hi. My name is John and I went to San Diego, Calif. on my vacation. I had a great time and the weather was beautiful.” Accordingly, content analysis process 50 will search the documents available on the Internet (or some other network) to determine which of these documents include these words. Naturally, common terms (e.g., “is”, “and”, “I”, “to”, etc.) will appear in a very high percentage of documents and will have little impact on relevancy statistic 52. Conversely, more unique terms (e.g., “John”, “San Diego”, weather”, etc.) will appear in fewer documents and, in turn, have a greater impact on relevancy statistic 52. The relevancy statistic 52 relating to each link 42 in the plurality of links 40 can be in the form of a numeric count of the total number of search terms embedded in the specific document (i.e., D1, D2, and D3). Further, this relevancy statistic 52 can be normalized and/or weighted if desired.

Link weighting process 44 further includes a link structure analysis process 54 for analyzing the quality of each of the plurality of Internet objects (i.e., D1, D2, and D3) linked to by each discrete link 42 in the plurality of links 40. This link structure analysis, which generates a quality statistic 56 for each Internet (or other network) document, is performed independent of the specific search terms included in the query processed by query analysis process 38. Quality statistic 56 consists of two components, namely an outgoing link statistic 58 and an incoming link statistic 60, which are summed in some fashion. Again, as above, this quality statistic 56 can be in the form of a relevancy score or an integer. Further, this score can be normalized and/or weighted if desired.

Link structure analysis process 54 includes an outgoing link analysis process 62 for determining the number of objects that each of the plurality of text-based objects is linked to. Specifically, if the text-based object in question is linked to a considerable number of objects, that text-based object is considered an information resource and, therefore, will have a high outgoing link statistic 58. The value of this outgoing link statistic 58 has a direct impact on the value of quality statistic 56, in that the higher the outgoing link statistic, the higher the quality statistic. Expanding on the above-stated example, document D1 is an information resource or hub in that it is linked to documents D2 and D4. Therefore, in this example, the outgoing link statistic 58 for document D1 would be a “2”, in that document D1 is linked to two documents. Alternatively, this statistic 58 can be in some other form (e.g., a relevancy score) and may be normalized/weighted if desired.

Link structure analysis process 54 includes an incoming link analysis process 64 for determining the number of objects linked to each of the plurality of Internet objects. Specifically, if an Internet object has a considerable number of objects linked to it, it is considered an information provider and, therefore, will have a high incoming link statistic 60. The value of this incoming link statistic 60 has a direct impact on the value of quality statistic 56, in that the higher the incoming link statistic, the higher the quality statistic. Expanding on the above-stated example, document D1 is an information provider for document D3, since document D3 is linked to document D1. Accordingly, in this example, the incoming link statistic 60 for document D1 would be “1”, in that one document is linked to document D1. Alternatively, this statistic 60 can be in some other form (e.g., a relevancy score) and may be normalized/weighted if desired.

Outgoing link statistic 58 and incoming link statistic 60 are then combined to generate quality statistic 56. As stated above, each off these statistics 58 and 60 can be weighted and/or normalized to tailor the process 34 to achieve the desired results.

Quality statistic 56, link use statistic 48, and relevancy statistic 52 are then combined to generate an individual link strength for each link 42 of the plurality of links 40, thus generating a plurality of link strengths 45. This plurality of link strengths 45 is then provided to a link strength summing process 68.

Link strength summing process 68 determines the link sum 70 of the plurality of link strengths 66, such that this link sum 70 corresponds to the popularity of text-based object 36. Expanding on the above-stated example, the plurality of links 40 consists of three discrete links, namely “Link 1”, “Link 2”, and “Link 3”. The respective link weights for these links are (1.00), (0.73), and (0.69). Therefore, the link sum 70 for text-based Internet object 36 is (2.42). Accordingly, the popularity of text-based object 36 is (2.42). Again, as above, this link sum 70 can also be in the form of a relevancy score (e.g. a percentage) or an integer. Further, this sum can be normalized and/or weighted as desired.

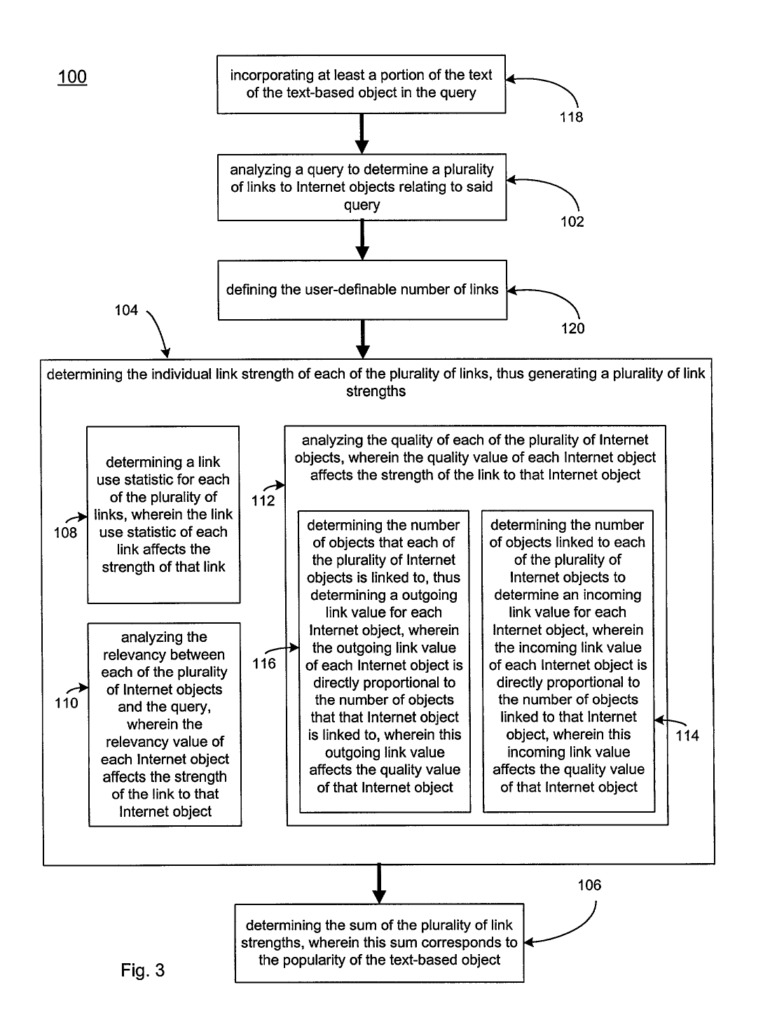

Now referring to FIG. 3, there is shown a method 100 for determining the popularity of a text-based object. A query analysis process analyzes 102 a query to determine a plurality of links to Internet objects relating to the query. A link weighting process determines 104 the individual link strength of each of the plurality of links, thus generating a plurality of link strengths. A link summing process determines 106 the sum of the plurality of link strengths, wherein this sum corresponds to the popularity of the text-based object.

Determining 104 the individual link strength of each of the plurality of links includes determining 108 a link use statistic for each of the plurality of links. The link use statistic of each link affects the strength of that link. Determining 104 the individual link strength of each of the plurality of links further includes analyzing 110 the relevancy between each of the plurality of Internet objects and the query. The relevancy value of each Internet object affects the strength of the link to that Internet object. Determining 104 the individual link strength of each of the plurality of links further includes analyzing 112 the quality of each of the plurality of Internet objects. The quality value of each Internet object affects the strength of the link to that Internet object.

Analyzing 112 the quality of each of the plurality of Internet objects includes determining 114 the number of objects linked to each of the plurality of Internet objects to determine an incoming link value for each Internet object. The incoming link value of each Internet object is directly proportional to the number of objects linked to that Internet object and this incoming link value affects the quality value of that Internet object.

Analyzing 112 the quality of each of the plurality of Internet objects includes determining 116 the number of objects that each of the plurality of Internet objects is linked to, thus determining an outgoing link value for each Internet object. The outgoing link value of each Internet object is directly proportional to the number of objects that that Internet object is linked to and this outgoing link value affects the quality value of that Internet object.

The query is a text-based query and the method 100 for determining the popularity of a text-based object further includes incorporating 118 at least a portion of the text of the text-based Internet object in the query. The plurality of links is a user-definable number of links and the method 100 for determining the popularity of a text-based object further includes defining 120 the user-definable number of links.

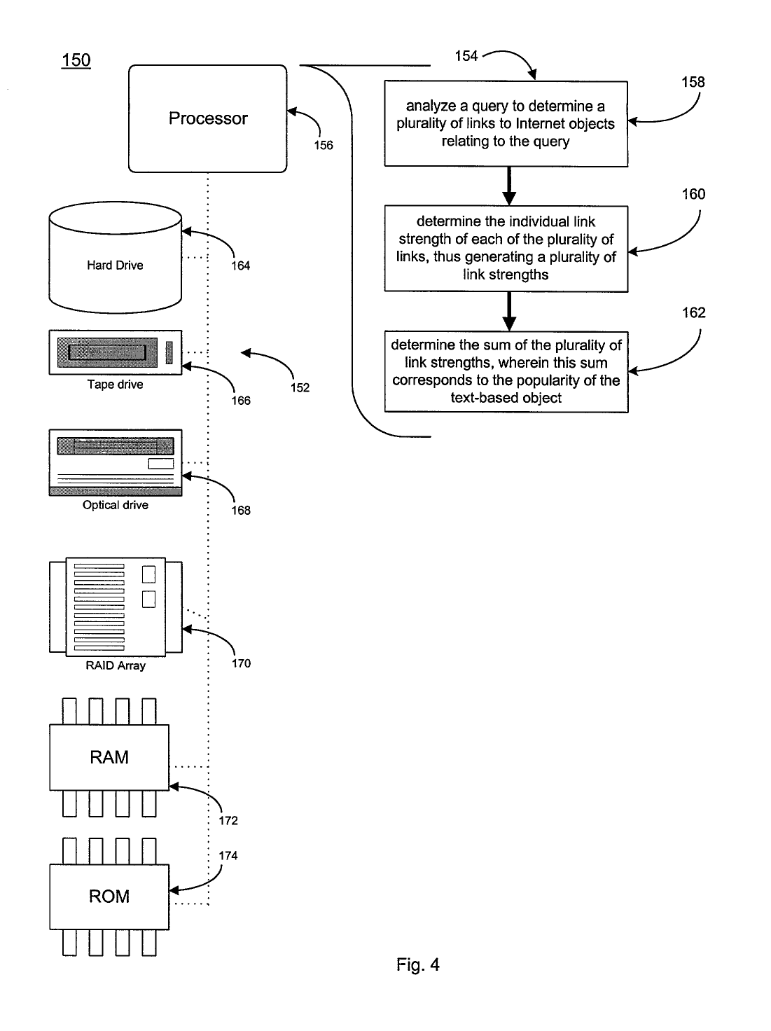

Now referring to FIG. 4, there is shown a computer program product 150 residing on a computer readable medium 152 having a plurality of instructions 154 stored thereon. When executed by processor 156, instructions 154 cause processor 156 to analyze 158 a query to determine a plurality of links to Internet objects relating to the query. Computer program product 150 determines 160 the individual link strength of each of the plurality of links, thus generating a plurality of link strengths. Computer program product 150 then determines 162 the sum of the plurality of link strengths, wherein this sum corresponds to the popularity of the text-based object.

Typical embodiments of computer readable medium 152 are: hard drive 164; tape drive 166; optical drive 168; RAID array 170; random access memory 172; and read only memory 174.

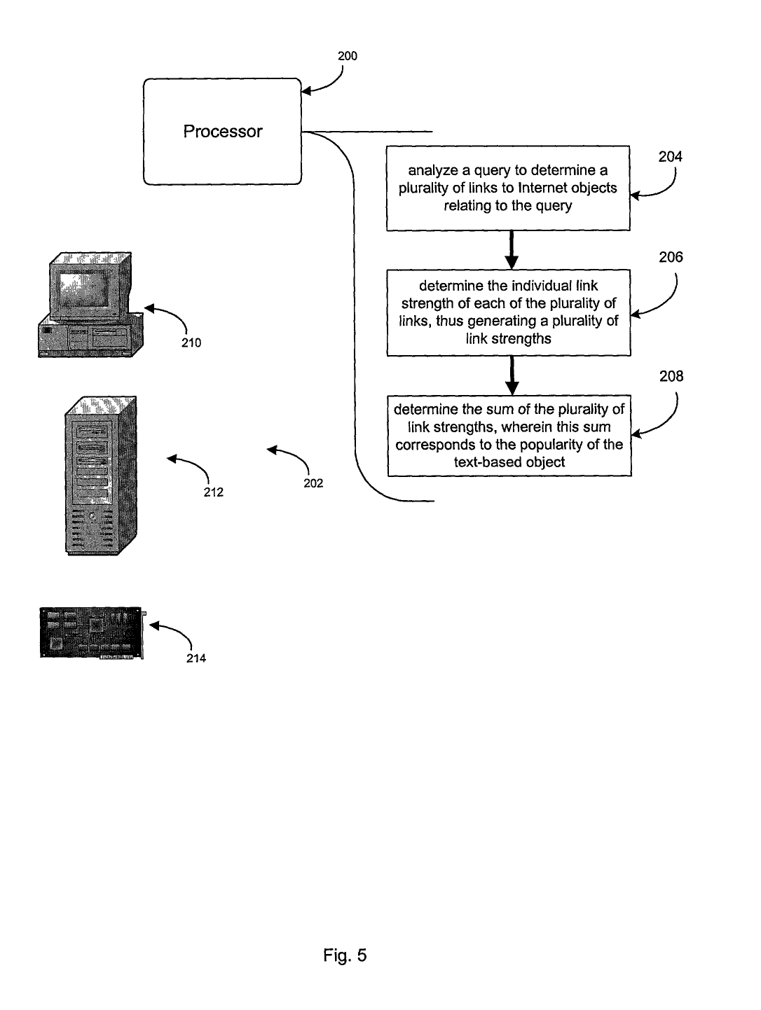

Now referring to FIG. 5, there is shown a processor 200 and memory 202 configured to analyze 204 a query to determine a plurality of links to Internet objects relating to the query. Processor 200 and memory 202 determine 206 the individual link strength of each of the plurality of links, thus generating a plurality of link strengths. Processor 200 and memory 202 then determine 208 the sum of the plurality of link strengths, wherein this sum corresponds to the popularity of the text-based object.

Processor 200 and memory 202 may be incorporated into a personal computer 210, a network server 212, or a single board computer 214.

A number of embodiments of the invention have been described. Nevertheless, it will be understood that various modifications may be made without departing from the spirit and scope of the invention. Accordingly, other embodiments are within the scope of the following claims.

What is claimed is:

1. A popularity predicting process for determining the popularity of a text-based object, comprising:
a query analysis process for analyzing a query to determine a plurality of links to Internet objects relating to said query;
a link weighting process for determining the individual link strength of each of said plurality of links, thus generating a plurality of link strengths; and
a link strength summing process for determining the sum of said plurality of link strengths, wherein said sum corresponds to the popularity of said text-based object.

2. The popularity predicting process of claim 1 wherein said link weighting process includes a click analysis process for determining a link use statistic for each of said plurality of links, wherein the link use statistic of each said link affects the strength of that link.

3. The popularity predicting process of claim 2 wherein said link use statistic is an integer specifying the number of times that that link was used prior to said query analysis process analyzing said query.

4. The popularity predicting process of claim 1 wherein said link weighting process includes a content analysis process for analyzing the relevancy between each of said plurality of Internet objects and said query, wherein the relevancy value of each said Internet object affects the strength of the link to that Internet object.

5. The popularity predicting process of claim 1 wherein said link weighting process includes a link structure analysis process for analyzing the quality of each of said plurality of Internet objects, wherein the quality value of each said Internet object affects the strength of the link to that Internet object.

6. The popularity predicting process of claim 5 wherein said link structure analysis process includes an incoming link analysis process for determining the number of objects linked to each of said plurality of Internet objects, wherein the incoming link value of each said Internet object is directly proportional to the number of objects linked to that Internet object, wherein said incoming link value affects said quality value of that Internet object.

7. The popularity predicting process of claim 5 wherein said link structure analysis process includes an outgoing link analysis process for determining the number of objects that each of said plurality of Internet objects is linked to, wherein the outgoing link value of each said Internet object is directly proportional to the number of objects that said Internet object is linked to, wherein said outgoing link value affects said quality value of that Internet object.

8. The popularity predicting process of claim 1 wherein each said link strength is a relevancy score.

9. The popularity predicting process of claim 8 wherein said relevancy score is a percentage.

10. The popularity predicting process of claim 1 wherein said query is a text-based query and includes at least a portion of the text of said text-based object.

11. The popularity predicting process of claim 10 wherein said text-based object is a query.

12. The popularity predicting process of claim 10 wherein said text-based object is a document.

13. The popularity predicting process of claim 1 wherein said plurality of links is a user-definable number of links and said popularity predicting process further comprises a link limitation process for defining said user-definable number of links.

14. The popularity predicting process of claim 1 further comprising an object conversion process for converting said text-based object into said query.

15. A popularity predicting process for determining the popularity of a text-based object, comprising:
a query analysis process for analyzing a query to determine a plurality of links to Internet objects relating to said query;
a link weighting process for determining the individual link strength of each of said plurality of links, thus generating a plurality of link strengths; and
a link strength summing process for determining the sum of said plurality of link strengths, wherein said sum corresponds to the popularity of said text-based object;
wherein said link weighting process includes a click analysis process for determining a link use statistic for each of said plurality of links, wherein the link use statistic of each said link affects the strength of that link.

16. The popularity predicting process of claim 15 wherein said link use statistic is an integer specifying the number of times that that link was used prior to said query analysis process analyzing said query.

17. A popularity predicting process for determining the popularity of a text-based object, comprising:
a query analysis process for analyzing a query to determine a plurality of links to Internet objects relating to said query;
a link weighting process for determining the individual link strength of each of said plurality of links, thus generating a plurality of link strengths; and
a link strength summing process for determining the sum of said plurality of link strengths, wherein said sum corresponds to the popularity of said text-based object;
wherein said link weighting process includes a link structure analysis process for analyzing the quality of each of said plurality of Internet objects, wherein the quality value of each said Internet object affects the strength of the link to that Internet object.

18. The popularity predicting process of claim 17 wherein said link structure analysis process includes an incoming link analysis process for determining the number of objects linked to each of said plurality of Internet objects, wherein the incoming link value of each said Internet object is directly proportional to the number of objects linked to that Internet object, wherein said incoming link value affects said quality value of that Internet object.

19. The popularity predicting process of claim 17 wherein said link structure analysis process includes an outgoing link analysis process for determining the number of objects that each of said plurality of Internet objects is linked to, wherein the outgoing link value of each said Internet object is directly proportional to the number of objects that said Internet object is linked to, wherein said outgoing link value affects said quality value of that Internet object.

20. A popularity predicting process for determining the popularity of a text-based object, comprising:
a query analysis process for analyzing a query to determine a plurality of links to Internet objects relating to said query;
a link weighting process for determining the individual link strength of each of said plurality of links, thus generating a plurality of link strengths; and
a link strength summing process for determining the sum of said plurality of link strengths, wherein said sum corresponds to the popularity of said text-based object;
wherein said link weighting process includes a content analysis process for analyzing the relevancy between each of said plurality of Internet objects and said query, wherein the relevancy value of each said Internet object affects the strength of the link to that Internet object.

21. A method for determining the popularity of a text-based object, comprising:
analyzing a query to determine a plurality of links to Internet objects relating to said query;
determining the individual link strength of each of the plurality of links, thus generating a plurality of link strengths; and
determining the sum of the plurality of link strengths, wherein this sum corresponds to the popularity of the text-based object.

22. The method for determining the popularity of a text-based object of claim 21 wherein determining the individual link strength includes determining a link use statistic for each of the plurality of links, wherein the link use statistic of each link affects the strength of that link.

23. The method for determining the popularity of a text-based object of claim 21 wherein determining the individual link strength includes analyzing the relevancy between each of the plurality of Internet objects and the query, wherein the relevancy value of each Internet object affects the strength of the link to that Internet object.

24. The method for determining the popularity of a text-based object of claim 21 wherein determining the individual link strength includes analyzing the quality of each of the plurality of Internet objects, wherein the quality value of each Internet object affects the strength of the link to that Internet object.

25. The method for determining the popularity of a text-based object of claim 24 wherein analyzing the quality of each of the plurality of Internet objects includes determining the number of objects linked to each of the plurality of Internet objects to determine an incoming link value for each Internet object, wherein the incoming link value of each Intern et object is directly proportional to the number of objects linked to that Internet object, wherein this in coming link value affects the quality value of that Internet object.

26. The method for determining the popularity of a text-based object of claim 24 wherein analyzing the quality of each of the plurality of Internet objects includes determining the number of objects that each of the plurality of Internet objects is linked to, thus determining an outgoing link value for each Internet object, wherein the outgoing link value of each Internet object is directly proportional to the number of objects that that Internet object is linked to, wherein this outgoing link value affects the quality value of that Internet object.

27. The method for determining the popularity of a text-based object of claim 21 wherein the query is a text-based query and the method for determining the popularity of a text-based object further comprises incorporating at least a portion of the text of the text-based Internet object in the query.

28. The method for determining the popularity of a text-based object of claim 21 wherein the plurality of links is a user-definable number of links and the method for determining the popularity of a text-based object further comprises defining the user-definable number of links.

29. A computer program product residing on a computer readable medium having a plurality of instructions stored thereon which, when executed by the processor, cause that processor to:
analyze a query to determine a plurality of links to Internet objects relating to the query;
determine the individual link strength of each of the plurality of links, thus generating a plurality of link strengths; and
determine the sum of the plurality of link strengths, wherein this sum corresponds to the popularity of the text-based object.

30. The computer program product of claim 29 wherein said computer readable medium is a random access memory (RAM).

31. The computer program product of claim 29 wherein said computer readable medium is a read only memory (ROM).

32. The computer program product of claim 29 wherein said computer readable medium is a hard disk drive.

33. A processor and memory configured to:
analyze a query to determine a plurality of links to Internet objects relating to the query;
determine the individual link strength of each of the plurality of links, thus generating a plurality of link strengths; and
determine the sum of the plurality of link strengths, wherein this sum corresponds to the popularity of the text-based object.

34. The processor and memory of claim 33 wherein said processor and memory are incorporated into a personal computer.

35. The processor and memory of claim 33 wherein said processor and memory are incorporated into a network server.

36. The processor and memory of claim 33 wherein said processor and memory are incorporated into a single board computer.

37. A popularity predicting process for determining the popularity of a text-based object, comprising:
an object conversion process for converting said text-based object into a query;
a query analysis process for analyzing said query to determine a plurality of links to Internet objects relating to said query;
a link weighting process for determining the individual link strength of each of said plurality of links, thus generating a plurality of link strengths; and
a link strength summing process for determining the sum of said plurality of link strengths, wherein said sum corresponds to the popularity of said text-based object.

38. A popularity predicting process for determining the popularity of a text-based object, comprising:
an object conversion process for converting said text-based object into a query;
a query analysis process for analyzing said query to determine a plurality of links to Internet objects relating to said query; and
a link weighting process for determining the individual link strength of each of said plurality of links, thus generating a plurality of link strengths.

39. The popularity predicting process of claim 38 further comprising a link strength summing process for determining the sum of said plurality of link strengths, wherein said sum corresponds to the popularity of said text-based object.

40. A popularity predicting process for determining the popularity of a text-based object, comprising:
a search engine for analyzing a query to determine a plurality of links to Internet objects relating to said query and for determining the individual link strength of each of said plurality of links, thus generating a plurality of link strengths; and
a link strength summing process for determining the sum of said plurality of link strengths, wherein said sum corresponds to the popularity of said text-based object.

41. The popularity predicting process of claim 40 wherein said search engine comprises:
a query analysis process for determining said plurality of links to Internet objects relating to said query; and
a link weighting process for determining said plurality of link strengths.

42. A popularity predicting process for determining the popularity of a text-based object, comprising:
an object conversion process for converting said text-based object into a query;
a search engine for analyzing said query to determine a plurality of links to Internet objects relating to said query and for determining the individual link strength of each of said plurality of links, thus generating a plurality of link strengths; and
a link strength summing process for determining the sum of said plurality of link strengths, wherein said sum corresponds to the popularity of said text-based object.

43. The popularity predicting process of claim 42 wherein said search engine comprises:
a query analysis process for determining said plurality of links to Internet objects relating to said query; and
a link weighting process for determining said plurality of link strengths.

44. A popularity predicting process for determining the popularity of a text-based object, comprising:
an object conversion process for converting said text-based object into a query; and
a search engine for analyzing said query to determine a plurality of links to Internet objects relating to said query and for determining the individual link strength of each of said plurality of links, thus generating a plurality of link strengths.

45. The popularity predicting process of claim 44 wherein said search engine comprises:
a query analysis process for determining said plurality of links to Internet objects relating to said query; and
a link weighting process for determining said plurality of link strengths.
